(19) United States
(12) Patent Application Publication
(10) Pub. No.: US 2023/0241719 A1
(43) Pub. Date: Aug. 3, 2023

(54) TECHNIQUES FOR CLOSED-LOOP CONTROL OF A LASER-ENGRAVING PROCESS

(71) Applicant: Standex International Corporation, Salem, NH (US)

(72) Inventors: Massimiliano MORUZZI, Rockford, IL (US); Francesco IORIO, Ontario (CA)

(21) Appl. No.: 17/966,551

(22) Filed: Oct. 14, 2022

Related U.S. Application Data
(60) Provisional application No. 63/305,139, filed on Jan. 31, 2022.

(51) Int. Cl. B23K 26/362

(52) U.S. Cl. CPC B23K 26/362

(57) ABSTRACT

A computer-implemented method for positioning a workpiece for a computer numerical controlled (CNC) process includes: causing a positioner to move an end effector to an initial position; receiving first position information associated with a first optical signal transmitted from a first optical target coupled to the workpiece; receiving second position information associated with a second optical signal transmitted from a second optical target coupled to the end effector; determining an offset between the initial position and a target position for the end effector based on the first position information and the second position information; and causing the positioner to move the end effector to a final position based on the offset.

### CROSS-REFERENCE TO RELATED APPLICATIONS

This application claims priority benefit of the U.S. Provisional Patent Application titled, “REAL-TIME MONITORING AND ADAPTING OF LASER ENGRAVING PROCESSES” filed on Jan. 31, 2022 and having Ser. No. 63/305,139. The subject matter of this related application is hereby incorporated herein by reference.

### BACKGROUND

### Field of the Various Embodiments

The various embodiments relate generally to laser engraving and computer numerical control (CNC) processing and, more specifically, to techniques for closed-loop control of a laser-engraving process.

### Description of the Related Art

Computer numerical control (CNC) processing systems, such as CNC machining systems, three-dimensional printers, and laser-engraving machines, are designed to process workpieces with precision and repeatability. Manufacturing techniques employing CNC processing systems oftentimes can be highly automated, which advantageously enables large volumes of uniform products to be produced, even when those products have complex, three-dimensional surfaces.

For a CNC processing system to operate properly, a given workpiece usually has to be positioned accurately and aligned precisely within the CNC processing system. For example, for a laser-engraving machine to generate certain specific surface textures or pattern geometries, a workpiece or mold sometimes has to be positioned on the work surface of the laser-engraving machine with sub-millimeter accuracy. Otherwise, when the actual location of a workpiece deviates too much from the target location, the overall laser-engraving process is oftentimes adversely affected.

To engrave a surface texture or pattern geometry on a workpiece surface via laser engraving, a laser-engraving head is employed that includes a mirror positioning system capable of directing a laser beam with high speed, precision, and repeatability. The mirror positioning system usually is configured to scan the laser beam in two different dimensions in order to reach any location within a given engraving region or “patch.” Because the area of a typical patch is relatively small, laser-engraving an entire workpiece surface usually involves processing numerous patches, where the laser-engraving head is repositioned each time a different patch is processed. Small inaccuracies in positioning the laser-engraving head at the start of any given patch can result in discontinuities in the rows of laser pulses that are used to engrave the entirety of a workpiece surface, thereby creating gaps in between various patches or areas in which two patches overlap. When these edge discontinuities are of sufficient size, for example on the order of a few microns or more, the discontinuities can form visible artifacts along the boundaries between the different patches on the workpiece surface. These types of visible artifacts are highly undesirable and, in some instances, can even negatively impact the intended properties of a laser-engraved surface. Accordingly, in an ideal laser-engraving process, the laser-engraving head is positioned and oriented relative to each patch with sufficient precision such that edge discontinuities between adjacent patches are avoided.

In an effort to minimize edge discontinuities, conventional laser-engraving systems are normally programmed to perform precise motions along or about various machine axes to properly position and orient the engraving head with respect to each patch on a workpiece surface. One drawback of conventional laser-engraving systems, though, is that conventional systems typically implement laser-engraving processes via open-loop control techniques, whereby the programmed motions of the various machine axes are independent of the actual position of the engraving head. As a result, conventional laser-engraving systems cannot adjust the programmed motions of the relevant machine axes in response to the engraving head or the workpiece deviating from a planned or programmed position. In practice, laser-engraving systems are oftentimes subject to thermal elongation, elastic deformation, and encoder delays that may not be accounted for in the programmed motions of a particular laser-engraving process, thereby resulting in workpiece position errors. In addition, the size, shape, and/or location of a workpiece can deviate from target values, which can also contribute to workpiece position errors. Because conventional laser-engraving systems cannot compensate in real-time for these types of position errors, edge discontinuities between adjacent patches can and do occur.

As the foregoing illustrates, what is needed in the art are more effective techniques for positioning an engraving head relative to a workpiece during a laser-engraving process.

### SUMMARY

A computer-implemented method for positioning a workpiece for a computer numerical controlled (CNC) process includes: causing a positioner to move an end effector to an initial position; receiving first position information associated with a first optical signal transmitted from a first optical target coupled to the workpiece; receiving second position information associated with a second optical signal transmitted from a second optical target coupled to the end effector; determining an offset between the initial position and a target position for the end effector based on the first position information and the second position information; and causing the positioner to move the end effector to a final position based on the offset.

At least one technical advantage of the disclosed techniques relative to the prior art is that the disclosed techniques enable a laser-engraving system to adjust the position of a laser-engraving head from a programmed position to a new position prior to processing a given patch on the surface of a workpiece. By compensating for position errors that are determined based on real-time position information, the effects of thermal elongation, elastic deformation, and encoder delays in the laser-engraving system can be reduced, which helps avoid edge discontinuities between adjacent patches when laser engraving the overall workpiece surface. These technical advantages provide one or more technological advancements over prior art approaches.

A computer-implemented method for performing laser engraving operations on a target engraving region includes: causing a positioner to move a laser-engraving head to a first position; while the laser-engraving head is disposed at the first position, determining a location of the target engraving region; while the laser-engraving head is disposed at the first position, determining a location of an actual engraving region; determining an offset based on the location of the target engraving region and the location of actual engraving region; modifying at least one process parameter value for an engraving head to generate a modified parameter value; and while the laser-engraving head is disposed at the first position, causing the laser-engraving head to perform one or more laser engraving operations based on the modified parameter value.

At least one technical advantage of the disclosed techniques relative to the prior art is that the disclosed techniques enable a laser-engraving system to adjust the position of an actual engraving region of a laser-engraving head to better align with previously processed patches on a surface of a workpiece. More particularly, with the disclosed techniques, the position of the actual engraving region of the laser-engraving head is adjusted based on location information for the previously processed patches that is collected via an inline camera. Such real-time feedback helps mitigate or prevent micron-scale discontinuities between the actual engraving region and the previously processed patches during laser engraving. These technical advantages provide one or more technological advancements over prior art approaches.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 illustrates a CNC processing system configured to implement one or more aspects of the various embodiments.

FIG. 2 sets forth a flowchart of method steps for positioning a workpiece within a CNC processing system, according to various embodiments.

FIG. 3 is a more detailed illustration of a workpiece that can be positioned within the CNC processing system of FIG. 1, according to various embodiments.

FIG. 4 is a schematic illustration of a laser-engraving apparatus that can be incorporated in the CNC processing system of FIG. 1, according to various embodiments.

FIG. 5 sets forth a flowchart of method steps for adjusting parameter values in a laser-engraving process, according to various embodiments.

FIGS. 6A-6D are more detailed illustrations of a specific engraving region on a surface of a workpiece that can be positioned within the CNC processing system of FIG. 1, according to various embodiments.

FIG. 7 is a block diagram of a computing device configured to implement one or more aspects of the various embodiments.

For clarity, identical reference numbers have been used, where applicable, to designate identical elements that are common between figures. It is contemplated that features of one embodiment may be incorporated in other embodiments without further recitation.

### DETAILED DESCRIPTION

In the following description, numerous specific details are set forth to provide a more thorough understanding of the various embodiments. However, it will be apparent to one of skill in the art that the inventive concepts may be practiced without one or more of these specific details.

### Real-Time Control of End Effector Position

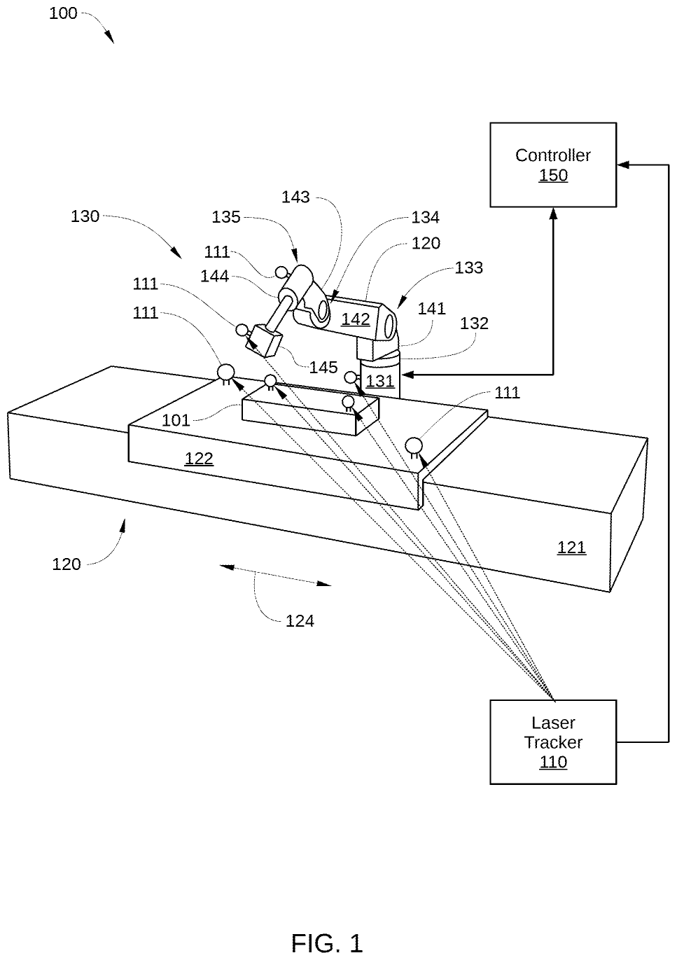

FIG. 1 illustrates a CNC processing system 100 configured to implement one or more aspects of the various embodiments. CNC processing system 100 can be any computer-controlled workpiece processing system, such as a machining system (mill, lathe, drill, and/or the like), an array of multiple such machining systems, a three-dimensional (3D) printer, a laser-engraving machine, and the like. As such, CNC processing system 100 is configured to perform one or more precise and repeatable processes on a workpiece 101, including material removal, surface texturization and/or functionalization, and coating application, among others. In the embodiment illustrated in FIG. 1, CNC processing system 100 includes a laser tracker 110, a table 120, a CNC positioner 130 and a controller 150.

Generally, the quality of the output of processes performed by CNC processing system 100 is dependent on accurate positioning of an end effector 145 of CNC positioner 130 relative to workpiece 101. For example, when a process is performed on multiple patches on a surface of workpiece 101, such as a laser-engraving process, micron-level accuracy in the selection of each patch can be beneficial to the quality of output. According to various embodiments, CNC processing system 100 includes a first closed-loop control system that enables precise positioning of end effector 145 for each patch that is processed on a surface of workpiece 101. As a result, each time that end effector 145 is repositioned, edge discontinuities between adjacent patches can be minimized, such as gaps between adjacent patches and areas in which two patches overlap. Further, according to various embodiments, CNC processing system 100 includes a second closed-loop control system that enables micron-scale adjustments to the position of each patch processed by a laser-engraving head (e.g., end effector 145). Specifically, the second closed-loop control system adjusts an actual engraving region associated with a particular patch to better align with a target engraving region for the particular patch and/or with previously processed patches. In such embodiments, the second closed-loop control system adjusts the size, shape, and/or location of the actual engraving region for the particular patch by modifying one or more process parameter values for the engraving head, such as focal shifter position and/or galvo-mirror position. Thus, the second closed-loop control system adjusts the actual engraving region to align with the target engraving region without repositioning the laser-engraving head.

Laser tracker 110 measures the three-dimensional position of various optical targets 111 positioned within CNC processing system 100 and on workpiece 101. Generally, laser tracker 110 measures each three-dimensional position with a laser beam and angular encoders. Laser tracker 110 can be any technically feasible laser tracker device known in the art, many of which are commercially available. In operation, for each optical target 111 positioned within CNC processing system 100 and/or on workpiece 101, laser tracker 110 directs a laser beam to the optical target 111, receives an optical signal (such as a return beam) from the optical target 111, determines the three-dimensional position of the optical target 111 based on the return beam, and generates position information for the optical target 111. The position information for each optical target 111 located within CNC processing system 100 and mounted on workpiece 101 is then provided to controller 150 as real-time position feedback.

In some embodiments, some or all of optical targets 111 are spherically mounted retroflectors (SMRs). An SMR is designed to reflect a laser beam back to laser tracker 110 with very little interference or distortion, and generally includes an outer shell (or “ball”) and one or more corner cube reflectors that have a reflective coating. As is well-known in the art, an SMR communicates position information to laser tracker 110 via the corner cube reflector. Specifically, an incident laser beam on an SMR from laser tracker 110 is directed to the center of the SMR and is reflected back to laser tracker 110 along a path that is parallel to but slightly offset from the incident laser beam. This offset is used by a position detector in laser tracker 110 to determine the location of the center of the SMR in three-dimensional space.

To determination whether end effector 145 and workpiece 101 are positioned appropriately for a portion of the surface of workpiece 101 to be processed by end effector 101, the position of end effector 145 in three-dimensional space and the position of workpiece 101 in three-dimensional space are both needed to a high level of precision. Thus, in general, CNC processing system 100 includes at least one optical target 111 on end effector 145 and one optical target 111 on a surface of workpiece 101. In some embodiments, to more precisely determine the position of end effector 145 and workpiece 101 relative to table 120 and various axes and arms of positioner 130, CNC processing system 100 includes additional optical targets 111. For instance, in some embodiments, an optical target 111 is mounted on each of a base 131 of positioner 130, some or all arms of positioner 130, and/or a movable stage 122 of table 120. In such embodiments, not only can the relative position in three-dimensional space between end effector 145 and workpiece 101 be determined, but also the relative position in three-dimensional space between end effector 145 and the various axes of positioner 130 and movable stage 121. Such position information enables controller 150 to adjust one or more axes of position 130 and/or movable stage 121 so that the position of end effector 145 (and/or movable stage 121) is changed from an initial, programmed position to a position that causes an actual engraving region to more closely align with a targeted engraving region. Thus, such position information provides real-time position feedback that facilitates adjustments to the position of end effector 145 (and/or movable stage 121).

Table 120 supports workpiece 101 during processing and, in the embodiment illustrated in FIG. 1, includes a base 121 and a movable stage 122 on which workpiece 101 is disposed. In some embodiments, movable stage 122 provides motion of workpiece 101 relative to positioner 130 along a single axis 124. In other embodiments, movable stage 122 provides motion of workpiece 101 relative to positioner 130 along a multiple axes, such as an XY or XYZ stage. As shown, in some embodiments, multiple optical targets 111 can be mounted to movable stage 122 and/or workpiece 101. In such embodiments, more accurate three-dimensional position information for movable stage 122 can be collected when the multiple optical targets 111 are positioned on opposite ends of movable stage 122. Similarly, in such embodiments, more accurate three-dimensional position information for workpiece 101 can be collected when the multiple optical targets 111 mounted on workpiece 101 are positioned on opposite ends of workpiece 101.

CNC positioner 130 is a multi-axis positioning apparatus, such as a polar axis machine, that locates and orients end effector 145 in two or three dimensions with respect to workpiece 101. For example, in embodiments in which end effector 145 includes a laser-engraving head, CNC positioner 130 sequentially positions the laser-engraving head at different positions over surfaces of workpiece 101. Thus, in such embodiments, discrete engraving regions (patches) on one or more surfaces of workpiece 101 can undergo laser engraving and have a final pattern formed thereon, such as a texture or other surface geometry.

In the embodiment illustrated in FIG. 1, CNC positioner 130 includes base 131, a first axis 132, a second axis 133, a third axis 134 and a fourth axis 135. In some embodiments, CNC positioner 130 can further include a fifth and sixth axis (not shown for clarity). CNC positioner 130 further includes a first arm 141 that is coupled to base 131 via first axis 132, a second arm 142 that is coupled to first arm 141 via second axis 133, a third arm 143 that is coupled to second arm 142 via third axis 134, a fourth arm 144 that is coupled to third arm 143 via fourth axis 135, and end effector 145, which is coupled to fourth arm 144. In other embodiments, laser-engraving system 100 includes more or fewer arms and/or joints than those shown in FIG. 1. Further, in some embodiments, CNC positioner 130 can have any other technically feasible multi-axis configuration, such as a Cartesian robot configuration. In some embodiments, base 131 is fixed in position relative to workpiece 101, for example to a supporting surface (not shown). In other embodiments, base 131 is configured to move relative to workpiece 100, for example in two or three dimensions.

End effector 145 is configured to perform one or more processes on workpiece 101, such as material removal (e.g., milling, drilling, and/or lathe operations), surface texturization and/or surface functionalization (e.g., via laser ablation), and the like. For example, in some embodiments, end effector 145 includes one or more motorized tools that are controlled based on machine control instructions for a specific process to be performed on workpiece 101. Alternatively or additionally, in some embodiments, end effector 145 includes a laser-engraving head.

In embodiments in which CNC processing system 100 is configured for performing a laser-engraving process, CNC positioner 130 includes optical and/or photonic fibers (not shown) that optically couple laser sources (not shown) to a laser-engraving head included in end effector 145. In such embodiments, the laser-engraving head typically includes or is coupled to a laser source for generating suitable laser pulses. In addition, the laser-engraving head typically includes a mirror positioning system and laser optics to direct the laser pulses to specific locations within an engraving region on a surface of workpiece 101.

Controller 150 controls the operations of CNC processing system 100. In some embodiments, controller 150 receives user inputs and/or a 3D model for a particular workpiece 101 via a human-machine interface (not shown). In some embodiments, controller 150 is further configured to generate and execute a sequential program of machine control instructions (e.g., G-code and/or M-code) based on the 3D model. Alternatively or additionally, in some embodiments, the 3D model includes a suitable sequential program of machine control instructions that are generated via computer-aided design (CAD) or computer-aided manufacturing (CAM) software by a computing device external to CNC processing system 100.

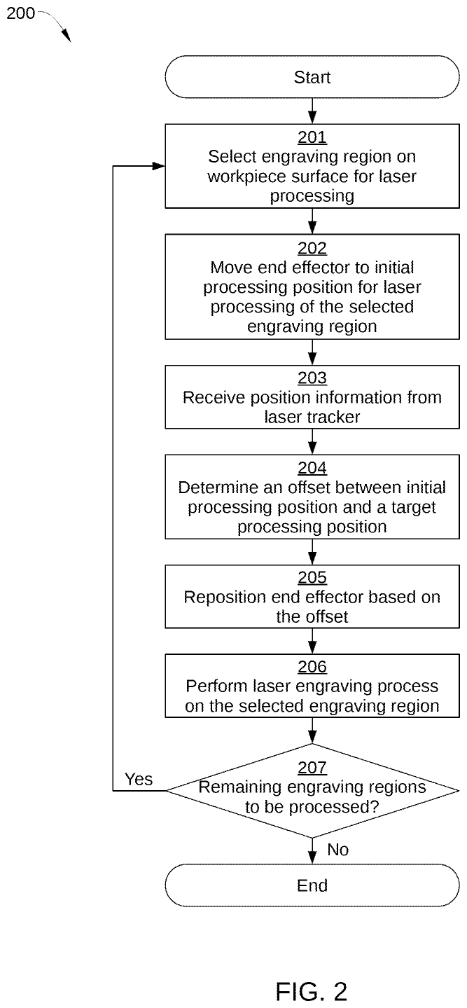

According to various embodiments, controller 150 adjusts a programmed position and/or orientation of end effector 145 to a final processing position and/or orientation based on real-time position feedback from laser tracker 110. Specifically, in some embodiments, controller 150 causes CNC positioner 130 to move end effector 145 to an initial processing position and orientation for processing a particular patch (or engraving region) on a surface of workpiece 101. CNC positioner 130 moves and orients end effector 145 to the initial processing position using an open-loop control system that dictates specific programmed motions of some or all of the joints and arms of CNC positioner 130. Controller 150 then receives position information from laser tracker 110 for end effector 145 and workpiece 101. In some embodiments, controller 150 receives additional position information from laser tracker 110 as well, such as position information associated with movable stage 121, base 131, and/or various arms of CNC position 130. Based on the received position information, controller 150 then determines an offset between the initial processing position and a target processing position for the end effector and, based on the offset, causes CNC positioner 130 to move end effector 145 to a final processing position. One such embodiment is described below in conjunction with FIG. 2.

FIG. 2 sets forth a flowchart of method steps for positioning a workpiece within a CNC processing system, according to various embodiments. Although the method steps are described in conjunction with the systems of FIG. 1, persons skilled in the art will understand that any system configured to perform the method steps, in any order, is within the scope of the embodiments.

As shown, a computer-implemented method 200 begins at step 201, where controller 150 selects an engraving region on a surface of workpiece 101 for laser processing. For example, when workpiece 101 includes one or more regions to be processed that are too large to undergo laser engraving without repositioning of end effector 145, each such surface is processed in multiple engraving regions. Thus, in step 201, controller 150 selects one such engraving regions.

In step 202, controller 150 causes CNC positioner 130 to move end effector 145 to an initial processing position and orientation for processing the selected engraving region. As noted above, in some embodiments, CNC positioner 130 moves and orients end effector 145 to the initial processing position using an open-loop control system based on specific programmed motions for some or all of the joints and arms of CNC positioner 130 and/or movable stage 121. Thus, in such embodiments, CNC positioner 130 moves end effector 145 and workpiece 101 to the initial processing position via open-loop control (e.g., without position feedback).

In step 203, controller 150 receives position information from laser tracker 110. Generally, the position information is based on optical signals received by laser tracker 110 from optical targets 111. In some embodiments, the position information is associated with end effector 145 and workpiece 101. In some embodiments, the position information received in step 203 may further include position information associated with other elements of CNC processing system 100, such as movable stage 122 and/or one or more arms or joints of CNC positioner 130.

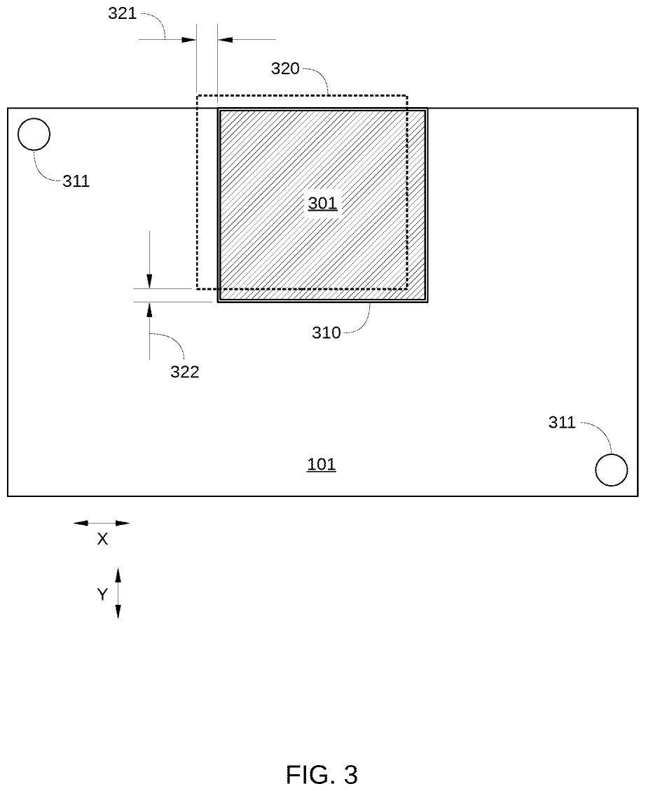

In step 204, controller 150 determines an offset between the initial processing position and a target processing position. For example, in some embodiments, controller 150 determines the offset based the on position information received in step 203. One such embodiment is illustrated in FIG. 3.

FIG. 3 is a more detailed illustration of workpiece 101, according to various embodiments. FIG. 3 is a plan view of workpiece 101 showing a target processing position 310 for end effector 145 and an initial processing position 320 of end effector 145. Target processing position 310 indicates an ideal location for end effector 145 to be located relative to workpiece 101 so that a particular engraving region 301 (cross-hatched area) on surface 302 of workpiece 101 is suitably processed by end effector 145. By contrast, initial processing position 320 of end effector 145 indicates the actual position of end effector 145 upon completion of step 202 in FIG. 2. That is, initial processing position 320 indicates the actual position of end effector 145 after end effector 145 has been positioned for processing of engraving region 301 via open loop, pre-programmed motions of CNC positioner 130. It is noted that each of target processing position 310 and initial processing position 320 is a position located in three-dimensional space relative to workpiece 101 and engraving region 301, but for clarity, each of target processing position 310 and initial processing position 320 is illustrated in two dimensions.

Ideally, CNC positioner 130 is programmed to precisely move end effector 145 to target processing position 310 in step 202 of FIG. 2. In practice, the various rigid components of CNC processing system 100 are subject to thermal elongation and elastic deformation, and the joints and actuators of CNC processing system are subject to encoder delays and bearing wear. Further, these factors can vary depending on a particular pose and/or temperature of CNC positioner 130. Consequently, these factors generally cannot be accurately accounted for in the programmed motions of CNC positioner 130. As a result, the pre-programmed motions of CNC positioner 130 typically result in end effector 145 being located at initial processing position 320 prior to processing of engraving region 301, instead of at target processing position 310.

As shown, initial processing position 310 is offset from target processing position 320 by an offset 321 in an X-direction and by an offset 322 in a Y-direction. Typically, initial processing position 310 can also be offset from target processing position 320 by an offset (not shown) in a Z-direction. Thus, the offset determined in step 205 of initial processing position 310 from target processing position 320 can include a component in the X-direction, the Y-direction, and/or the Z-direction. Further, in some embodiments, the offset determined in step 205 can further include a rotational component.

According to various embodiments, controller 150 determines offset 321, offset 322, the offset in the Z-direction, and any applicable rotational offset based on position information from laser tracker 110. For example, such position information can be based on one or more optical signals from optical targets 311 disposed on workpiece 101, optical targets disposed on end effector 145, optical targets disposed on movable stage 121, and/or optical targets disposed on various elements of CNC positioner 130.

Returning to FIG. 2, in step 205, controller 150 causes CNC positioner 130 to reposition end effector 145 to reduce or eliminate the offset determined in step 205. In some embodiments, controller 150 determines appropriate motions of CNC positioner and/or movable stage 122 to reduce or eliminate the offset determined in step 205, causes CNC positioner 130 to perform the motions, then causes end effector 145 to perform the appropriate processing of the selected engraving region. In other embodiments, an iterative approach is employed, in which controller 150 determines a first set of motions of CNC positioner and/or movable stage, causes CNC positioner 130 to perform the first set of motions, then repeats steps 203 and 204. That is, in each iteration of steps 203 and 204, controller 150 determines the resultant offset between the current processing position of end effector 145 and target processing processing position 310 based on position information received from laser tracker 110. In such embodiments, when the resultant offset is below a threshold value, controller 150 causes end effector 145 to perform the appropriate processing of the selected engraving region. Otherwise, steps 203 and 204 are again repeated.

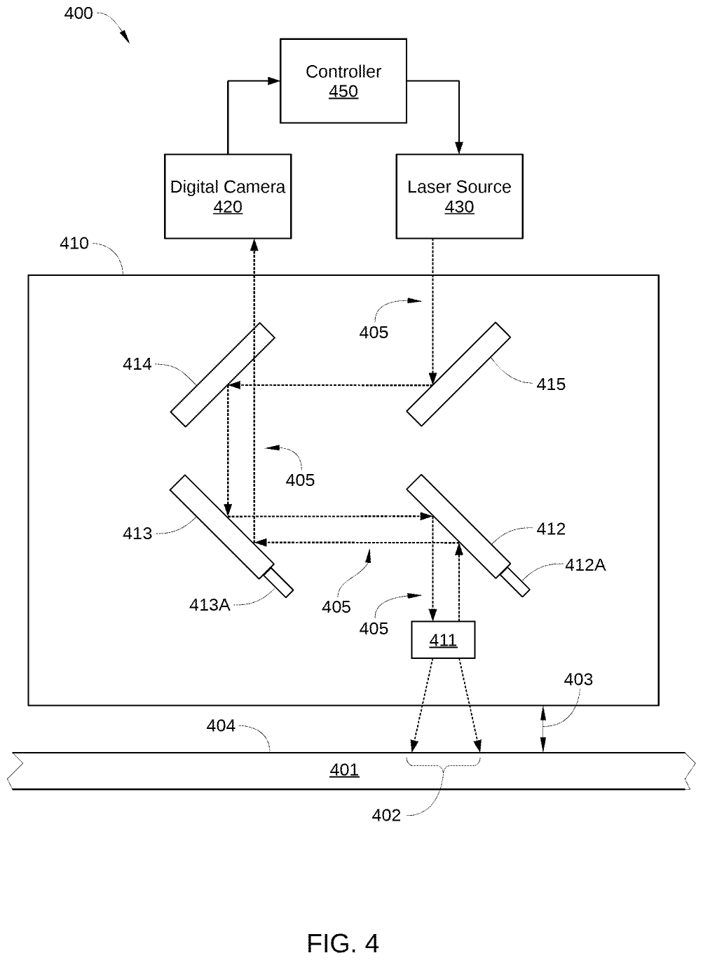

In step 206, controller 150 cause end effector to perform the appropriate laser-engraving process on engraving region 301. Alternatively, in some embodiments, prior to performing the appropriate laser-engraving process in step 206, controller 150 performs additional operations that enable micron-level alignment between engraving region 301 and previously processed engraving regions on surface 302 of workpiece 101. These operations modify one or more process parameter values for an engraving head included in end effector 145, such as focal shifter position and/or galvo-mirror position via a closed-loop control system. Such embodiments are described below in conjunction with FIGS. 4-6D.

In step 207, controller 150 determines whether there are any remaining engraving regions to be processed on a surface of workpiece 101. If yes, method 200 returns to step 201; if no, method 200 terminates.

### Micron-Scale Adjustment of Laser-Engraving Process

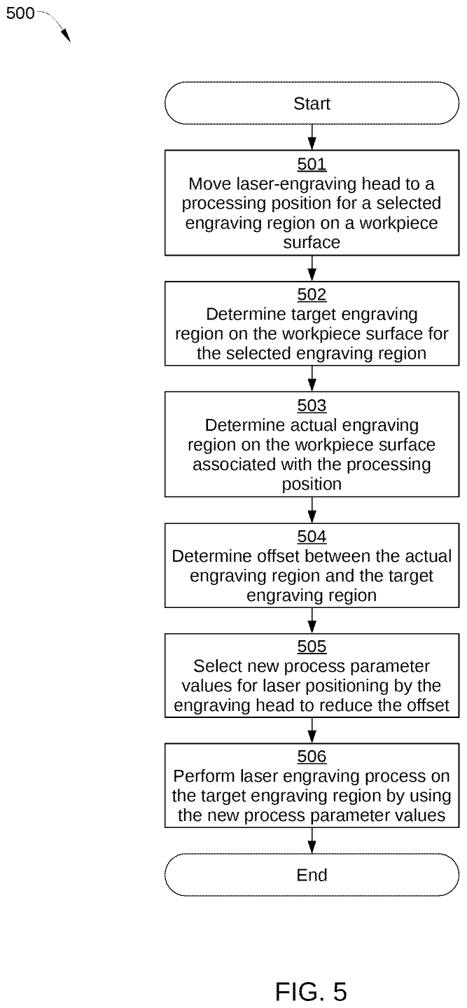

Method 200 can be employed to reposition an end effector in a CNC processing system to compensate for factors that cannot be accurately accounted for in the programmed motions of the CNC processing system. As a result, the different patches on a workpiece that are processed by the CNC processing system can be aligned with an accuracy that corresponds to the control tolerances of the positioner of the CNC processing system. However, certain processes require micron-level alignment of each patch to avoid visible edge discontinuities, and no CNC processing system positioner can be controlled to such high tolerances. According to various embodiments, a closed-loop control system enables micron-scale adjustments to the position and/or shape of each patch processed by a laser-engraving head, so that such edge discontinuities can be reduced or eliminated. One such embodiment is described below in conjunction with FIGS. 4 and 5.

FIG. 4 is a schematic illustration of a laser-engraving apparatus 400, according to various embodiments. Laser-engraving apparatus 400 can be incorporated into end effector 145 of FIG. 1, or can be employed as an end effector in any other suitably configured CNC processing system. According to various embodiments, for a particular engraving region, laser-engraving apparatus 400 adjusts the size, shape, and/or location of an actual engraving region by modifying one or more process parameter values for a laser-engraving head 410. Examples of such process parameter values include values for focal shifter position and/or galvo-mirror position. The size, shape, and/or location of the actual engraving region is adjusted based on the size, shape, and location of a target engraving region, which is determined via real-time feedback that indicates position information for previously processed engraving regions. Thus, the actual engraving region can be precisely aligned with previously processed engraving regions, and the formation of edge discontinuities on a workpiece surface can be reduced or eliminated.

As shown, laser-engraving apparatus 400 includes laser-engraving head 410, a digital camera 420, a laser source 430, and a controller 450. Each of digital camera 420 and laser source 430 is optically coupled to laser-engraving head 410, for example via optical cables and/or photonic cables (not shown).

Laser-engraving head 410 performs a laser-engraving process on an engraving region 402 of a surface of a workpiece 401 by directing laser pulses onto engraving region 402 according to a specified process. Laser-engraving head 410 performs the laser-engraving process when laser-engraving head 410 is suitably positioned and oriented relative to workpiece 401, for example using method 200 of FIG. 2. Generally, laser-engraving head 410 includes a focus shifter 411 and a mirror positioning system and other laser optics that direct laser pulses to specific locations within engraving region 402. In the embodiment illustrated in FIG. 4, laser-engraving head 410 includes focus shifter 411, a first mirror 412 that is actuated by a galvanometer motor 412A, a second mirror 413 that is actuated by a galvanometer motor 413A, a dichroic mirror 414, and one or more additional optical elements 415. Thus, in the embodiment illustrated in FIG. 4, laser-engraving head 410 includes a 2-axis deflection unit that deflects a laser beam in two directions and enables the laser beam to be directed to precise locations within a two-dimensional area, referred to herein as the field of operation of laser-engraving head 410. Specifically, the 2-axis deflection unit is configured with two galvanometer scanners (first mirror 412 and galvanometer motor 412A and second mirror 413 and galvanometer motor 413A) that each deflect the laser beam along a different direction within the field of operation of laser-engraving head 410.

Focus shifter 411, also referred to as a “dynamic focal module,” is a well-known optical device configured to change a focal length of a laser beam received from laser source 430, thereby compensating for changes in a distance 403 between laser-engraving head 410 and a surface 404 of engraving region 402 during three-dimensional scanning operations. Dichroic mirror 414 directs laser pulses from laser source 430 along an optical path 405 from laser source 430 to focus shifter 411, and allows light returning along optical path 405 from engraving region 402 to leave optical path 405 and reach digital camera 420. The one or more additional optical elements 415 can include any additional lenses, mirrors, fibers, and/or waveguides that facilitate or enable operation of optical path 405.

Digital camera 420 can be any digital image capture system capable of generating image information, such as digital images, of a portion of surface 404 of workpiece 401. In some embodiments, the portion of surface 404 that is imaged by digital camera 420 corresponds to the field of operation of laser-engraving head 410, and in other embodiments, the portion of surface 404 that is imaged by digital camera 420 can extend beyond the field of operation of laser-engraving head 410. In either case, images generated by digital camera 420 of the portion of surface 404 provide a “beam's-eye view” of at least the field of operation of laser engraving head 410. Thus, real-time position feedback associated with surface 404 can be provided to controller 450.

In some embodiments, digital camera 420 includes computer vision logic that can detect one or more features on surface 404, based on image information included in a digital image of the field of operation of laser-engraving head 410. Examples of such features include, without limitation: an inscribed line formed on the workpiece surface, for example from a previous manufacturing operation; a machined feature formed on the workpiece surface, such as a drilled hole, a radius, a corner, or an edge; an edge of surface 404 and/or workpiece 401; or an edge of a previously processed engraving region on surface 404. In some embodiments, such computer vision logic can be incorporated in controller 450 instead of digital camera 420.

Laser source 430 is a laser source suitable for use by laser-engraving head 410 in a laser-engraving process. For example, in an embodiment, laser source 430 is one of a longer pulse-width laser source, such as a nanosecond pulse-width laser, a shorter pulse-width laser source, such as a picosecond pulse-width laser, or a still shorter pulse-width laser source, such as a femtosecond pulse-width laser. Further, laser source 430 is capable of generating a laser beam of a specified laser power (e.g., 100 W, 75 W, 50 W, and/or the like) and having specified spot size for a particular laser-engraving process.

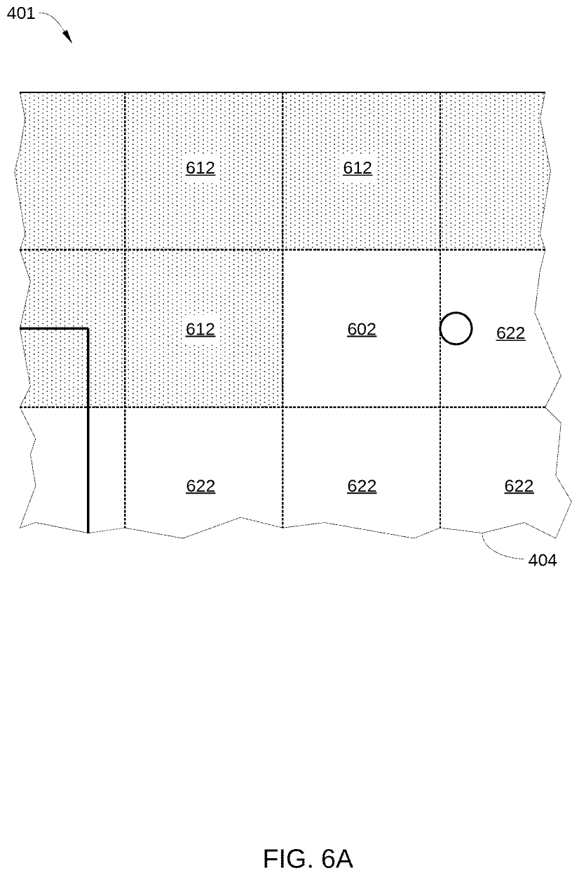

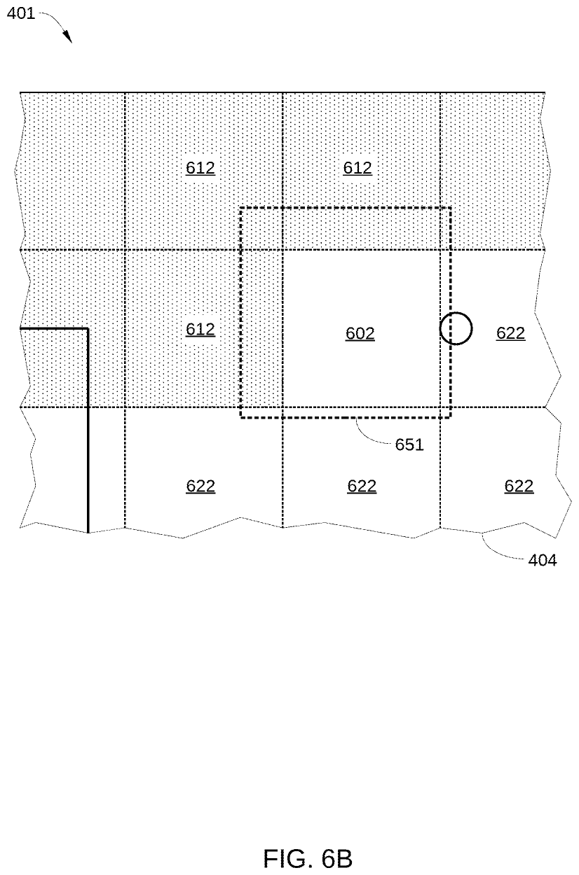

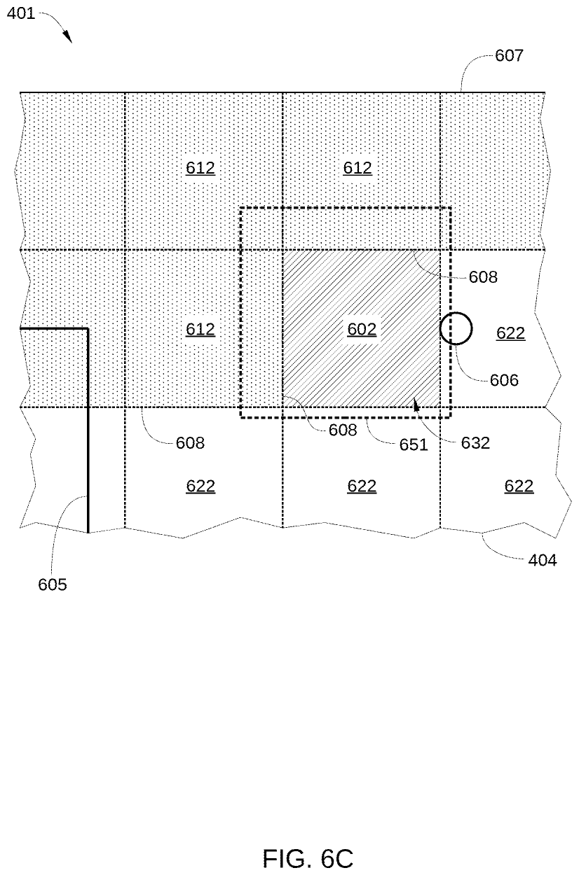

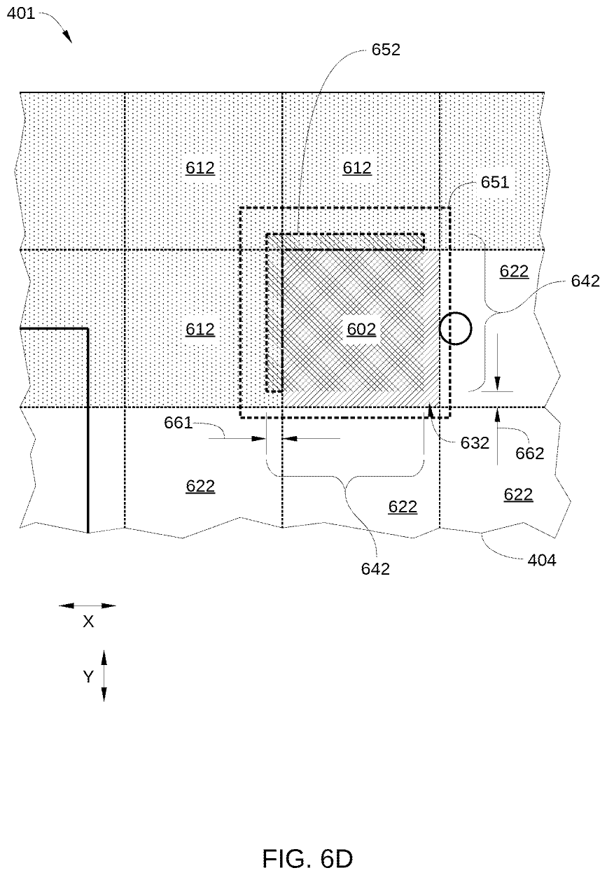

Controller 450 controls the operations of laser-engraving head 410. In some embodiments, some or all of the functionality described herein for controller 450 can be included in controller 150 of FIG. 1. According to various embodiments, controller 450 enables micron-scale adjustments to the position of each engraving region 402 that is processed by laser-engraving head 410, such that each particular engraving region 402 better aligns with a corresponding target engraving region for that particular engraving region 402 and/or with previously processed engraving regions (not shown) on surface 404. Specifically, in some embodiments, controller 450 receives digital images of or image information associated with surface 404 from digital camera 420, and then determines the size, shape, and/or location of a target engraving region on surface 404 based on the digital images or image information. Controller 450 then determines an actual engraving region of laser-engraving head 410 based on the current position of laser-engraving head 410, and then determines an offset between the target engraving region and the actual engraving region. Based on the offset, controller 450 modifies one or more process parameter values for laser-engraving head 410, such that the offset between the target engraving region and the actual engraving region is reduced or eliminated. One such embodiment is described below in conjunction with FIGS. 5 and 6.

FIG. 5 sets forth a flowchart of method steps for adjusting parameter values in a laser-engraving process, according to various embodiments. Although the method steps are described in conjunction with the systems of FIGS. 1 and 4, persons skilled in the art will understand that any system configured to perform the method steps, in any order, is within the scope of the embodiments.

As shown, a computer-implemented method 500 begins at step 501, where laser-engraving-head 410 is moved to a programmed processing position for a particular engraving region 402 on surface 404 of workpiece 401. For example, in some embodiments, laser-engraving head 410 is suitably positioned and oriented at the programmed processing position relative to workpiece 401 using method 200 of FIG. 2. One embodiment of a particular engraving region 402 on surface 404 when laser-engraving-head 410 is disposed at a programmed processing position is described below in conjunction with FIGS. 6A and 6B.

FIG. 6A is a more detailed illustration of a specific engraving region 602 on surface 404 of workpiece 401, according to various embodiments. FIG. 6A is a plan view (or beam's-eye-view) of workpiece 401 showing a portion of surface 404 that includes specific engraving region 602 and multiple adjacent engraving regions. The multiple adjacent engraving regions include processed engraving regions 612 and unprocessed engraving regions 622. Thus, processed engraving regions 612 are depicted with a laser-engraved pattern that has been generated previously by laser-engraving head 410 (shown in FIG. 4), while unprocessed engraving regions 622 are depicted as untreated surfaces.

FIG. 6B is a more detailed illustration of specific engraving region 602 and a field of operation 651 of laser-engraving head 410, according to various embodiments. Field of operation 651 indicates a region of surface 404 of workpiece 401 within which laser-engraving head 410 can direct laser pulses (and therefore perform a laser-engraving process) when laser-engraving head 410 is disposed at the programmed processing position associated with specific engraving region 602. As noted previously, for certain CNC processes, such as laser-engraving processes, micron-level alignment may be required of each engraving region on surface 404 to avoid visible edge discontinuities between processed engraving regions 612. Further, the control tolerances of the positioners of CNC processing systems cannot meet such high tolerances when positioning an end effector, such as laser-engraving head 410. Thus, as shown in FIG. 6B, positioning laser-engraving head 410 at the programmed processing position associated with specific engraving region 602 generally results in field of operation 651 being poorly aligned with adjacent engraving regions, such as processed engraving regions 612 and unprocessed engraving regions 622.

Returning to FIG. 5, in step 502, while engraving-head 410 is disposed at the programmed processing position, controller 450 determines a target engraving region for selected engraving region 602 (shown in FIGS. 6A-6D). One embodiment of a target engraving region for selected engraving region 602 is described below in conjunction with FIG. 6C.

FIG. 6C is a more detailed illustration of specific engraving region 602 and an associated target engraving region 632 (cross-hatched), according to various embodiments. For reference, field of operation 651 is also shown in FIG. 6C. Target engraving region 632 indicates an ideal region of surface 404 within which laser-engraving head 410 direct laser pulses (and therefore performs a laser-engraving process) when specific engraving region 602 is engraved by laser-engraving head 410. According to various embodiments, controller 450 determines target engraving region 632 based on one or more features on surface 404 that are disposed within a field of view of digital camera 420 or within field of operation 651. In such embodiments, the positions of such features are determined by controller 450, based on image information collected by digital camera 420 when laser-engraving head 410 is disposed at the programmed processing position for specific engraving region 602. Examples of such features include an inscribed line 605 formed on 404, a machined feature 606 formed on surface 404, an edge 607 of workpiece 401, and an edge 608 of a previously processed engraving region on surface 404. Thus, controller 450 can determine target engraving region 632 based on the actual positions of processed engraving regions 612 and other datum features. Consequently, when one or more of processed engraving regions 612 are mispositioned on surface 404, controller 450 can determine the boundaries of target engraving region 632, so that little or no edge discontinuities are formed between specific engraving region 602 and processed engraving regions 612.

Returning to FIG. 5, in step 503, while engraving-head 410 is disposed at the programmed processing position, controller 450 determines an actual engraving region for selected engraving region 602 that is associated with the programmed processing position. One embodiment of an actual engraving region associated with the programmed processing position for selected engraving region 602 is described below in conjunction with FIG. 6D.

FIG. 6D is a more detailed illustration of specific engraving region 602 and an associated actual engraving region 642 (cross-hatched), according to various embodiments. For reference, field of operation 651 and target engraving region 632 are also shown in FIG. 6D. Actual engraving region 642 indicates a region of surface 404 within which laser-engraving head 410 direct laser pulses when specific engraving region 602 is engraved while engraving-head 410 is disposed at the programmed processing position. Because field of operation 651 is poorly aligned with adjacent engraving regions, actual engraving region 642 is also poorly aligned with adjacent engraving regions. Therefore, because target engraving region 632 can be based at least in part on the positions of adjacent engraving regions (e.g., processed engraving regions 612 and unprocessed engraving regions 622), there is generally an offset between actual engraving region 642 and target engraving region 632.

In the embodiment illustrated in FIG. 6D, the offset can include a first offset 661 in the X-direction and a second offset 662 in the Y-direction. As shown, first offset 661 and second offset 662 result in an overlap region 652 between actual engraving region 642 and processed engraving regions 612, which can create visible edges discontinuities between processed engraving regions 612 and specific engraving region 602. Similarly, first offset 661 and second offset 662 result in a gap between actual engraving region 642 and unprocessed engraving regions 622. After unprocessed engraving regions 622 are laser-engraved, such a gap can create visible edges discontinuities between unprocessed engraving regions 622 and specific engraving region 602.

Additionally or alternatively, in some embodiments, the offset between actual engraving region 642 and target engraving region 632 can further include an offset in the Z-direction. Such an offset is not visible in FIG. 6D, because the Z-direction is into the page. In such embodiments, when the programmed position of laser-engraving head 410 is too close to surface 404, actual engraving region 642 is generally smaller than target engraving region 632, and when the programmed of laser-engraving head 410 is too far from surface 404, actual engraving region 642 is generally larger than target engraving region 632.

In some embodiments, controller 450 determines actual engraving region 642 based on image information provided by digital camera 420. Alternatively or additionally, in some embodiments, controller 450 determines actual engraving region 642 based on laser-engraving head 410 performing an initial portion of the laser-engraving process on specific engraving region 602 and receiving image information from digital camera 420 showing the results of the initial portion of the laser-engraving process. Thus, in one such embodiment, controller 450 causes laser-engraving head 410 to direct laser pulses to a portion of actual engraving region 642, such as a portion of an edge of actual engraving region 642, one or more corners of actual engraving region 642, one or more linear paths within actual engraving region 642, and the like. Image information showing the locations of such laser pulses on surface 404 can then indicate the size, shape, and/or location of actual engraving region 642.

In step 504, controller 450 determines the offset between actual engraving region 642 and target engraving region 632. In some embodiments, controller 450 determines the offset based on position information associated with actual engraving region 642 and target engraving region 632. As described above, such position information can be determined based on image information provided to controller 450 by digital camera 420. Further, the offset can include an offset in the X-direction, an offset in the Y-direction, and/or an offset in the Z-direction.

In step 505, controller 450 selects one or more new process parameter values for laser-engraving head 410 to reduce the offset determined in step 504. Examples of such process parameter values include values for focal shifter position and/or galvo-mirror position. Thus, in such embodiments, travel of first mirror 412 and/or second mirror 413 is modified so that the laser-engraving process is performed within target engraving region 632 instead of actual engraving region 642. Alternatively or additionally, a position of focus shifter 411 is modified so that the laser-engraving process is performed within target engraving region 632 instead of actual engraving region 642. It is noted that in step 505, new values are selected for process parameters that affect the locations on surface 404 to which laser pulses are directed. By contrast, values for process parameters for laser-engraving head 410 that affect the resultant surface or functionalization of surface 404 remain unchanged, such as laser power, laser pulse frequency, and the like. Thus, the new values selected in step 505 do not change how surface 404 is modified by laser-engraving head 410, but instead change which locations on surface 404 are actually modified by laser-engraving head 410 during step 506.

In some embodiments, an iterative approach is employed in step 505 to select the one or more new process parameter values. In such embodiments, controller 450 determines a first set of one or more new process parameter values for laser-engraving head 410, causes laser-engraving head 410 to perform a small portion or an initial portion of the laser-engraving process on specific engraving region 602, and receives updated image information for surface 404. Controller 450 then confirms whether the new process parameter values for laser-engraving head 410 sufficiently reduce the offset determined in step 504 and repeats the process if necessary.

In step 506, controller 450 causes laser-engraving head 410 to perform the laser-engraving process on surface 404 using the one or more new process parameter values. Because laser-engraving head 410 uses the one or more new process parameter values, the region of surface 404 that undergoes the laser-engraving process coincides substantially or entirely with target engraving region 632 rather than actual engraving region 642. Thus, the use of the one or more process parameter values alter the locations on surface 404 that are actually modified by laser-engraving head 410.

In some embodiments, controller selects one or more new process parameter values during step 506, so that the laser-engraving process coincides substantially or entirely with target engraving region 632 rather than actual engraving region 642. In such embodiments, image information of surface 404 that is provided by digital camera 420 provides real-time feedback for the laser-engraving process while the laser-engraving process in being performed on specific engraving region 602. Thus, in such embodiments, controller 450 can modify a number of laser pulses included in a row of laser pulses when a remainder portion of target engraving region 632 differs from a remainder portion of laser pulses in the row. For example, when controller 450 determines that 10% of the length of a region to be processed remains to be processed while 5% of the total laser pulses for that region remain, controller can select process parameter values for laser-engraving head 410 to extend the travel of first mirror 412 and/or second mirror 413 and/or cause additional pulses to the region to be processed.

### Exemplary Computing Device

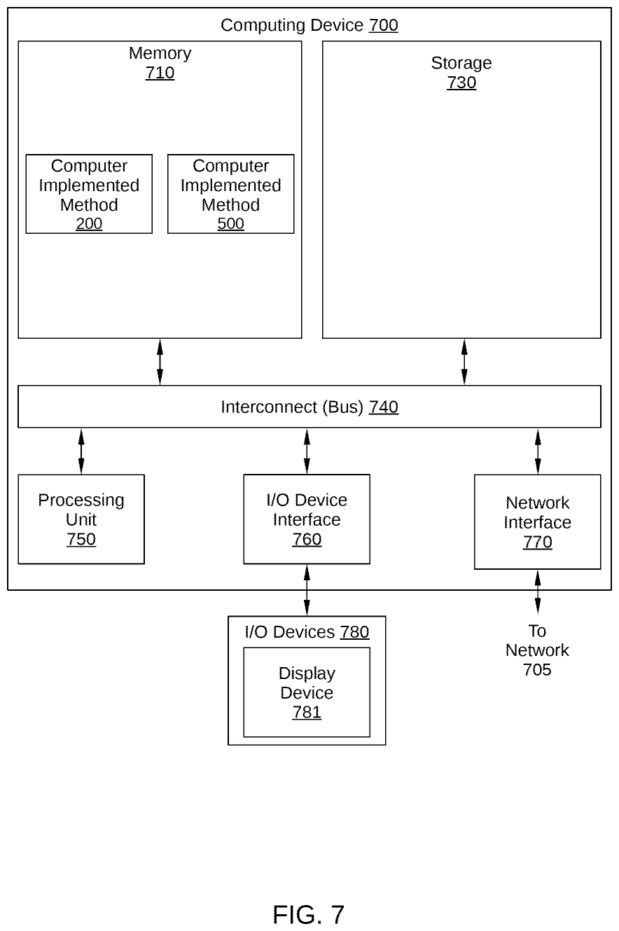

FIG. 7 is a block diagram of a computing device 700 configured to implement one or more aspects of the various embodiments. Thus, computing device 700 can be a computing device associated with CNC processing system 100, controller 150, and/or controller 450. Computing device 700 may be a desktop computer, a laptop computer, a tablet computer, or any other type of computing device configured to receive input, process data, generate control signals, and display images. Computing device 700 is configured to perform operations associated with computer-implemented method 200, computer-implemented method 500, and/or other suitable software applications, which can reside in a memory 710. It is noted that the computing device described herein is illustrative and that any other technically feasible configurations fall within the scope of the present disclosure.

As shown, computing device 700 includes, without limitation, an interconnect (bus) 740 that connects a processing unit 750, an input/output (I/O) device interface 760 coupled to input/output (I/O) devices 780, memory 710, a storage 730, and a network interface 770. Processing unit 750 may be any suitable processor implemented as a central processing unit (CPU), a graphics processing unit (GPU), an application-specific integrated circuit (ASIC), a field programmable gate array (FPGA), any other type of processing unit, or a combination of different processing units, such as a CPU configured to operate in conjunction with a GPU. In general, processing unit 750 may be any technically feasible hardware unit capable of processing data and/or executing software applications, including processes associated with computer-implemented method 300. Further, in the context of this disclosure, the computing elements shown in computing device 700 may correspond to a physical computing system (e.g., a system in a data center) or may be a virtual computing instance executing within a computing cloud.

I/O devices 780 may include devices capable of providing input, such as a keyboard, a mouse, a touch-sensitive screen, and so forth, as well as devices capable of providing output, such as a display device 781. Additionally, I/O devices 780 may include devices capable of both receiving input and providing output, such as a touchscreen, a universal serial bus (USB) port, and so forth. I/O devices 780 may be configured to receive various types of input from an end-user of computing device 700, and to also provide various types of output to the end-user of computing device 700, such as one or more graphical user interfaces (GUI), displayed digital images, and/or digital videos. In some embodiments, one or more of I/O devices 780 are configured to couple computing device 700 to a network 705.

Memory 710 may include a random access memory (RAM) module, a flash memory unit, or any other type of memory unit or combination thereof. Processing unit 750, I/O device interface 760, and network interface 770 are configured to read data from and write data to memory 710. Memory 710 includes various software programs that can be executed by processor 750 and application data associated with said software programs, including computer-implemented method 200 and/or computer-implemented method 500.

In sum, the various embodiments described herein provide techniques for preventing edge discontinuities between adjacent patches when laser engraving an overall workpiece surface. In some embodiments, a first closed-loop control system enables precise positioning of the end effector of a CNC processing system for each patch that is processed on a surface of a workpiece. In the embodiments, the feedback for the first closed-loop control system is based on real-time position information generated using optical targets positioned on the workpiece, the end effector, and movable elements of a positioner included in the CNC processing system. In some embodiments, a second closed-loop control system adjusts the size, shape, and/or location of an actual engraving region for a particular patch to better align the actual engraving region with a target engraving region for the particular patch and/or with previously processed patches. Based on image information generated with an in-line digital camera, the second closed loop control system modifies one or more process parameter values for the engraving head, such as focal shifter position and/or galvo-mirror position. In this way, the actual engraving region for the particular patch is better aligned with the target engraving region for the particular patch.

At least one technical advantage of the disclosed techniques relative to the prior art is that the disclosed techniques enable a laser-engraving system to adjust the position of a laser-engraving head from a programmed position to a new position prior to processing a given patch on the surface of a workpiece. By compensating for position errors that are determined based on real-time position information, the effects of thermal elongation, elastic deformation, and encoder delays in the laser-engraving system can be reduced, which helps avoid edge discontinuities between adjacent patches when laser engraving the overall workpiece surface. These technical advantages provide one or more technological advancements over prior art approaches.

At least one technical advantage of the disclosed techniques relative to the prior art is that the disclosed techniques enable a laser-engraving system to adjust the position of an actual engraving region of a laser-engraving head to better align with previously processed patches on a surface of a workpiece. More particularly, with the disclosed techniques, the position of the actual engraving region of the laser-engraving head is adjusted based on location information for the previously processed patches that is collected via an inline camera. Such real-time feedback helps mitigate or prevent micron-scale discontinuities between the actual engraving region and the previously processed patches during laser engraving. These technical advantages provide one or more technological advancements over prior art approaches.

1. In some embodiments, a computer-implemented method for positioning a workpiece for a computer numerical controlled (CNC) process includes: causing a positioner to move an end effector to an initial position; receiving first position information associated with a first optical signal transmitted from a first optical target coupled to the workpiece; receiving second position information associated with a second optical signal transmitted from a second optical target coupled to the end effector; determining an offset between the initial position and a target position for the end effector based on the first position information and the second position information; and causing the positioner to move the end effector to a final position based on the offset.

2. The computer-implemented method of clause 1, wherein the positioner moves the end effector to the final position prior to when the end effector performs a processing operation on the workpiece.

3. The computer-implemented method of clauses 1 or 2, wherein determining the offset between the initial position and the target position for the end effector comprises determining an actual position of the workpiece based on the first position information and an actual position of the end effector based on the second position information.

4. The computer-implemented method of any of clauses 1-3, further comprising determining the initial position of the end effector based on at least the second position information.

5. The computer-implemented method of any of clauses 1-4, further comprising determining the initial position of the end effector based on the second position information and third position information that is associated with a third optical signal transmitted from a third optical target coupled to the positioner.

6. The computer-implemented method of any of clauses 1-5, wherein the third optical target is coupled to one of a stationary base of the positioner or a movable arm of the positioner.

7. The computer-implemented method of any of clauses 1-6, wherein determining the initial position of the end effector is further based on fourth position information that is associated with a fourth optical signal transmitted from a fourth optical target coupled to the positioner.

8. The computer-implemented method of any of clauses 1-7, wherein determining the offset between the initial position and the target position of the end effector is further based on third position information associated with a third optical signal transmitted from a third optical target coupled to a movable stage on which the workpiece is disposed.

9. The computer-implemented method of any of clauses 1-8, wherein the third position information is associated with multiple optical targets coupled to the movable stage.

10. The computer-implemented method of any of clauses 1-9, further comprising, prior to determining the offset, causing a movable stage to move the workpiece to an initial workpiece processing position.

11. The computer-implemented method of any of clauses 1-10, further comprising causing the movable stage to move the workpiece to a final workpiece processing position based on the offset.

12. The computer-implemented method of any of clauses 1-12, further comprising causing the end effector to perform at least one processing operation on the workpiece while the workpiece is disposed at the final processing position.

13. The computer-implemented method of any of clauses 1-12, wherein the end effector is moved to the initial position via an open-loop control technique.

14. In some embodiments, a system includes: a positioner having an end effector; a laser tracker that determines first position information associated with a first optical signal transmitted from a first optical target coupled to a workpiece and second position information associated with a second optical signal transmitted from a second optical target coupled to the end effector; and a controller that executes instructions and performs the steps of: causing the positioner to move the end effector to an initial position; receiving the first position information from the laser tracker; receiving the second position information from the laser tracker; determining an offset between the initial position and a target position for the end effector based on the first position information and the second position information; and causing the positioner to move the end effector to a final processing position based on the offset.

15. The system of clause 14, wherein the end effector comprises a laser-engraving head.

16. The system of clauses 14 or 15, wherein the target position is associated with a specific engraving region on a surface of the workpiece that is processed when the laser-engraving head is in the target position.

17. The system of any of clauses 14-16, further comprising a movable stage that supports the workpiece and a third optical target that is coupled to the movable stage.

18. The system of any of clauses 14-17, wherein the controller determines the offset between the initial position and the target position of the end effector based on third position information associated with a third optical signal transmitted from the third optical target.

19. The system of any of clauses 14-18, further comprising causing the end effector to perform at least one processing operation on the workpiece while the workpiece is disposed at the final processing position.

20. The system of any of clauses 14-19, wherein the end effector is moved to the initial position via an open-loop control technique.

Any and all combinations of any of the claim elements recited in any of the claims and/or any elements described in this application, in any fashion, fall within the contemplated scope of the present invention and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module,” a “system,” or a “computer.” In addition, any hardware and/or software technique, process, function, component, engine, module, or system described in the present disclosure may be implemented as a circuit or set of circuits. Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method for positioning a workpiece for a computer numerical controlled (CNC) process, the method comprising:
causing a positioner to move an end effector to an initial position;
receiving first position information associated with a first optical signal transmitted from a first optical target coupled to the workpiece;
receiving second position information associated with a second optical signal transmitted from a second optical target coupled to the end effector;
determining an offset between the initial position and a target position for the end effector based on the first position information and the second position information; and
causing the positioner to move the end effector to a final position based on the offset.

2. The computer-implemented method of claim 1, wherein the positioner moves the end effector to the final position prior to when the end effector performs a processing operation on the workpiece.

3. The computer-implemented method of claim 1, wherein determining the offset between the initial position and the target position for the end effector comprises determining an actual position of the workpiece based on the first position information and an actual position of the end effector based on the second position information.

4. The computer-implemented method of claim 1, further comprising determining the initial position of the end effector based on at least the second position information.

5. The computer-implemented method of claim 1, further comprising determining the initial position of the end effector based on the second position information and third position information that is associated with a third optical signal transmitted from a third optical target coupled to the positioner.

6. The computer-implemented method of claim 5, wherein the third optical target is coupled to one of a stationary base of the positioner or a movable arm of the positioner.

7. The computer-implemented method of claim 5, wherein determining the initial position of the end effector is further based on fourth position information that is associated with a fourth optical signal transmitted from a fourth optical target coupled to the positioner.

8. The computer-implemented method of claim 1, wherein determining the offset between the initial position and the target position of the end effector is further based on third position information associated with a third optical signal transmitted from a third optical target coupled to a movable stage on which the workpiece is disposed.

9. The computer-implemented method of claim 8, wherein the third position information is associated with multiple optical targets coupled to the movable stage.

10. The computer-implemented method of claim 1, further comprising, prior to determining the offset, causing a movable stage to move the workpiece to an initial workpiece processing position.

11. The computer-implemented method of claim 10, further comprising causing the movable stage to move the workpiece to a final workpiece processing position based on the offset.

12. The computer-implemented method of claim 1, further comprising causing the end effector to perform at least one processing operation on the workpiece while the workpiece is disposed at the final processing position.

13. The computer-implemented method of claim 1, wherein the end effector is moved to the initial position via an open-loop control technique.

14. A system, comprising:
a positioner having an end effector;
a laser tracker that determines first position information associated with a first optical signal transmitted from a first optical target coupled to a workpiece and second position information associated with a second optical signal transmitted from a second optical target coupled to the end effector; and
a controller that executes instructions and performs the steps of:
causing the positioner to move the end effector to an initial position;
receiving the first position information from the laser tracker;
receiving the second position information from the laser tracker;
determining an offset between the initial position and a target position for the end effector based on the first position information and the second position information; and
causing the positioner to move the end effector to a final processing position based on the offset.

15. The system of claim 14, wherein the end effector comprises a laser-engraving head.

16. The system of claim 15, wherein the target position is associated with a specific engraving region on a surface of the workpiece that is processed when the laser-engraving head is in the target position.

17. The system of claim 14, further comprising a movable stage that supports the workpiece and a third optical target that is coupled to the movable stage.

18. The system of claim 17, wherein the controller determines the offset between the initial position and the target position of the end effector based on third position information associated with a third optical signal transmitted from the third optical target.

19. The system of claim 1, further comprising causing the end effector to perform at least one processing operation on the workpiece while the workpiece is disposed at the final processing position.

20. The system of claim 1, wherein the end effector is moved to the initial position via an open-loop control technique.
